(19) United States
(12) Patent Application Publication
(10) Pub. No.: US 2013/0311934 A1
(43) Pub. Date: Nov. 21, 2013

(54) METHOD FOR DISPLAYING MULTI MENU PAGES IN ONE WINDOW OF MULTI-TOUCH-SENSITIVE DISPLAY UNIT OF COMPUTING DEVICE AND COMPUTING DEVICE APPLYING THE METHOD

(71) Applicants: Fei WU, Taipei City (TW); Yu-Ting HSU, Taipei City (TW); Hsin-Yu HUANG, Taipei City (TW); Ming-Che WENG, Taipei City (TW)

(72) Inventors: Fei WU, Taipei City (TW); Yu-Ting HSU, Taipei City (TW); Hsin-Yu HUANG, Taipei City (TW); Ming-Che WENG, Taipei City (TW)

(73) Assignee: COMPAL ELECTRONICS, INC., Taipei City (TW)

(21) Appl. No.: 13/472,503

(22) Filed: May 16, 2012

(51) Int. Cl. G06F 3/048; G06F 3/041

(52) U.S. Cl. 715/781; 715/784; 345/173

(57) ABSTRACT

A method for displaying multi menu pages in one window of a multi-touch-sensitive display unit of a computing device is disclosed. A menu is constituted by several menu pages and each of the menu pages comprises at s least one object. In the method, an image of one of the plurality of menu pages is displayed in the window of the multi-touch-sensitive display unit. A continuous squeezing signal is detected by a touch sensor of the multi-touch-sensitive display unit or an input unit of the computing device. The graphic module processes the continuous squeezing signal and displays the current squeezed menu page until at least two menu pages being displayed in the window of the multi-touch-sensitive display unit. Wherein, each of the displayed menu pages in the window comprises only a portion of the original content thereof. A computing device applying the method is also disclosed.

### BACKGROUND

1. Technical Field

The present invention relates to a method for displaying and a computing device applying the method. More particularly, the present invention relates to a method for displaying multi menu pages in one window of a multi-touch-sensitive display unit of a computing device and a computing device applying the method.

2. Description of Related Art

In computer technology, a graphical user interface (GUI) is a type of user interface that allows users to interact with their electronic apparatuses with image icons rather than text commands. A GUI represents the information and actions available to a user through image icons. The image icons represent objects or functions accessible on the system of the electrical apparatus, and enable the user to perform tasks utilizing the electrical apparatus.

GUIs can be used in computers, mobile apparatuses (e.g., MP3 players, portable media players and gaming apparatuses), household appliances and office equipment. Since a typical mobile apparatus is equipped with a small size multi-touch-sensitive display unit, several GUI desktop pages, each of which includes several icons, can be provided for display on such a mobile apparatus. However, before selecting an application program, a user has to switch among the desktop pages until the desktop page with the desired icon is found. Undergoing such a process each time an application program is selected is not convenient.

### SUMMARY

According to one embodiment of this invention, a method for displaying multi menu pages in one window of a multi-touch-sensitive display unit of a computing device is provided. A menu is constituted by the multi menu pages and each of the menu pages includes at least one object. In the display method,

an image of one of the plurality of menu pages is displayed in the window of the multi-touch-sensitive display unit, and a graphic module processes a continuous squeezing signal detected by a touch sensor of the multi-touch-sensitive display unit or an input unit of the computing device, and the graphic module displays the current squeezed menu page until at least two menu pages being displayed in the window of the multi-touch-sensitive display unit, wherein each of the displayed menu pages in the window comprises only a portion of the original content thereof.

According to another embodiment of this invention, a computing device is provided. The computing device includes a multi-touch-sensitive display unit, an input unit, a storage unit and a graphic processing unit. The graphic processing unit is electrically connected to the multi-touch-sensitive display unit, the input unit and the storage unit. The storage unit stores multi menu pages. A menu is constituted according to the multi menu pages and each of the menu pages comprises at least one object. The graphic processing unit outputs an image of a menu page to the multi-touch-sensitive display unit and squeezes the current displayed menu page based on a continuous squeezing signal detected by the touch sensor of the multi-touch-sensitive display unit or the input unit until each of the displayed menu pages in the window comprises only a portion of the original content thereof.

The present invention can achieve many advantages. A user can select objects in different menu pages without switching among the menu pages to search for a particular object. Hence, convenience is provided to users. In in some embodiments, because the multi-touch-sensitive display unit of the computing device is a touch screen, a user does not have to make sliding gestures on the touch screen for objects in different pages utilizing the present application. This provides for particular convenience when the number of the preset menu pages is large.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 illustrates a flow diagram of a method for displaying multi menu pages in one window of a multi-touch-sensitive display unit of a computing device according to one embodiment of this invention;

FIG. 2 illustrates multi menu pages according to one embodiment of this invention;

FIG. 3A and FIG. 3B illustrate embodiments of the manner in which the window of the multi-touch-sensitive display unit of the computing device;

FIG. 4 illustrates an embodiment of the manner in which several pages are respectively displayed in the regions of the multi-touch-sensitive display unit;

FIG. 5 illustrates an embodiment of the manner in which one of the pages is displayed on the whole window of the multi-touch-sensitive display unit; and

FIG. 6 illustrates a block diagram of a computing device according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

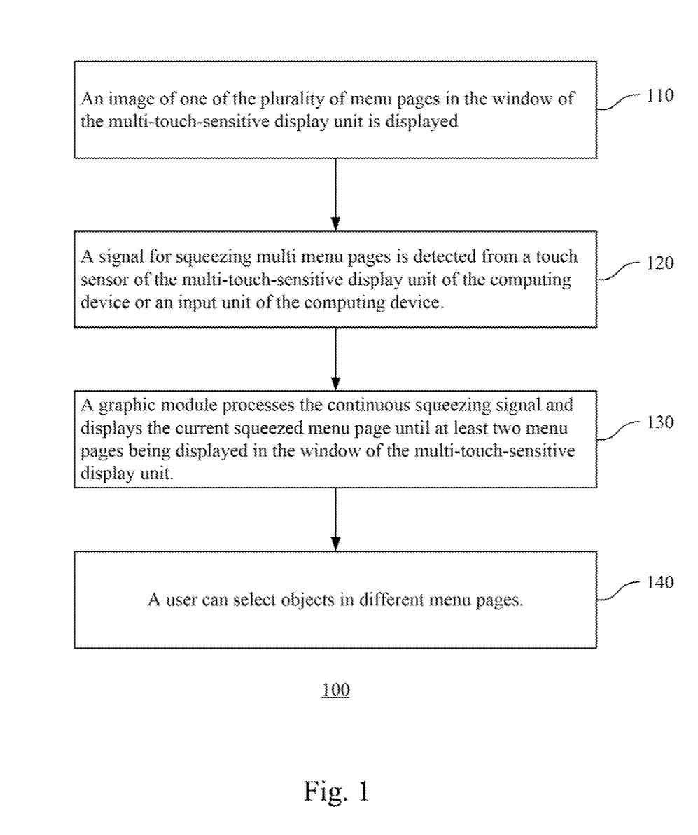

FIG. 1 illustrates a flow diagram of a method for displaying multi menu pages in one window of a multi-touch-sensitive display unit of a computing device according to one embodiment of this invention. The method can be implemented as a computer program product. The computer program product stores a computer program for a computing device. When a computing device with a multi-touch-sensitive display unit loads the computer program stored in the computer program product, the computing device can execute the method. The computer program product may be stored in any suitable storage medium including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate to random access memory (DDR-RAM); optical storage devices such as compact disc read only memories (CD-ROMs) and digital versatile disc read' only memories (DVD-ROMs); and magnetic storage devices such as hard disk drives (HDD) and floppy disk drives.

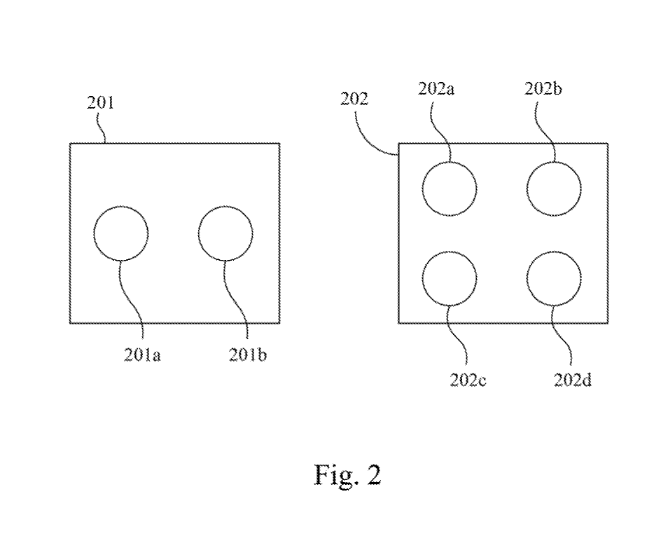

A menu is constituted by the multi menu pages and each of the pages includes at least one object. FIG. 2 illustrates multi menu pages 201, 202 according to one embodiment of this invention. The menu page 201 includes several objects 201a, 201b, and the menu page 202 includes several objects 202a, 202b, 202c, 202d. Each object 201a, 201b, 202a, 202b, 202c, 202d may be an icon, a widget, a program or any other object to be displayed on the multi-touch-sensitive display unit of the computing device for executing an application program or representing a file.

The routine 100 of the method begins at operation 110, where an image of one of the plurality of menu pages in the window of the multi-touch-sensitive display unit is displayed.

The routine 100 continues from operation 110 to operation 120, where a signal for squeezing multi menu pages is detected from a touch sensor of the multi-touch-sensitive display unit of the computing device or an input unit of the computing device. In one embodiment, the signal for squeezing multi menu pages may be generated when a user makes a squeezing gesture or any other squeezing action on the touch sensor of the multi-touch-sensitive display unit.

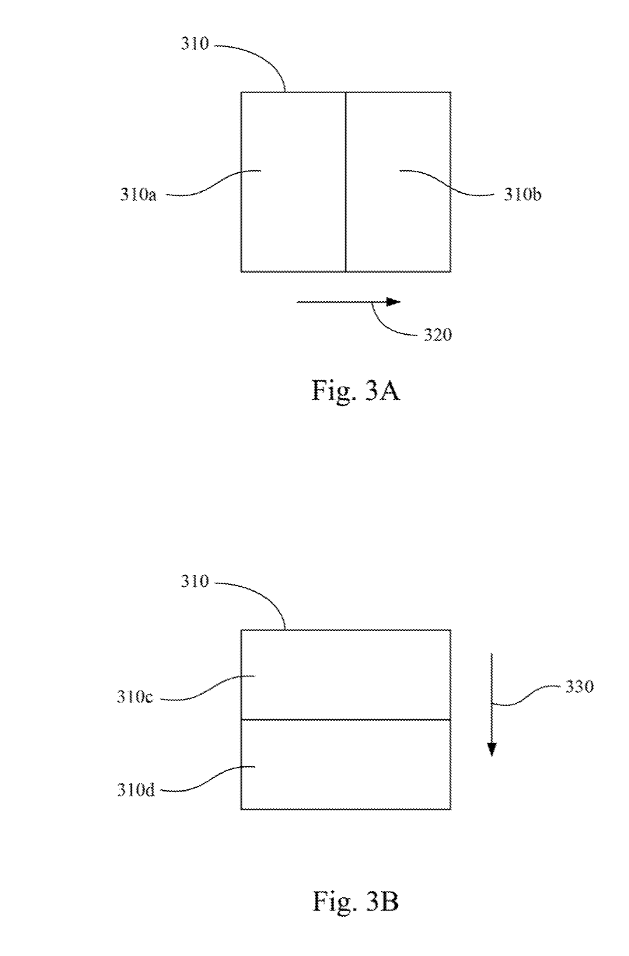

The routine 100 continues from operation 120 to operation 130, where a graphic module processes the continuous squeezing signal and displays the current squeezed menu page until at least two menu pages being displayed in o the window of the multi-touch-sensitive display unit. FIG. 3A illustrates an embodiment of the manner in which at least two menu pages being displayed in the window of the multi-touch-sensitive display unit. In this embodiment, the window 310 of the multi-touch-sensitive display unit of the computing device displays several (i.e., two) squeezed menu pages 310a, 310b in a horizontal arrangement 320. FIG. 3B illustrates another embodiment of the manner in which at least two menu pages being displayed in the window of the multi-touch-sensitive display unit. In this embodiment, the window 310 of the multi-touch-sensitive display unit of the computing device displays several (i.e., two) squeezed menu pages 310c, 310d in a vertical arrangement 330. In some embodiments, the squeezed menu pages of the multi-touch-sensitive display unit of the computing device can be scrolled sequentially according to a scroll instruction received through the computing device.

At least one object of each menu page is displayed in each corresponding squeezed menu page of the window of the multi-touch-sensitive display unit. The object displayed in each corresponding squeezed menu page is selected from the corresponding menu page. In one embodiment, the object displayed in each corresponding squeezed menu page is part of the at least one object (or only a portion of the original content in each corresponding squeezed menu page) of the corresponding menu page. In another embodiment, the object displayed in each corresponding squeezed menu page are all of the at least one object of the corresponding menu page.

Subsequently, objects in different menu pages can be provided on the window of the multi-touch-sensitive display unit of the computing device for selection at the same time. Therefore, a user can select objects in different o menu pages without switching among the menu pages to search for a particular object at operation 140. Hence, convenience is provided to users. In some embodiments, when the multi-touch-sensitive display unit of the computing device is a touch screen, a user does not have to make sliding gestures on the touch screen for objects in different pages utilizing the present application. This provides for particular convenience when the number of the pages is large.

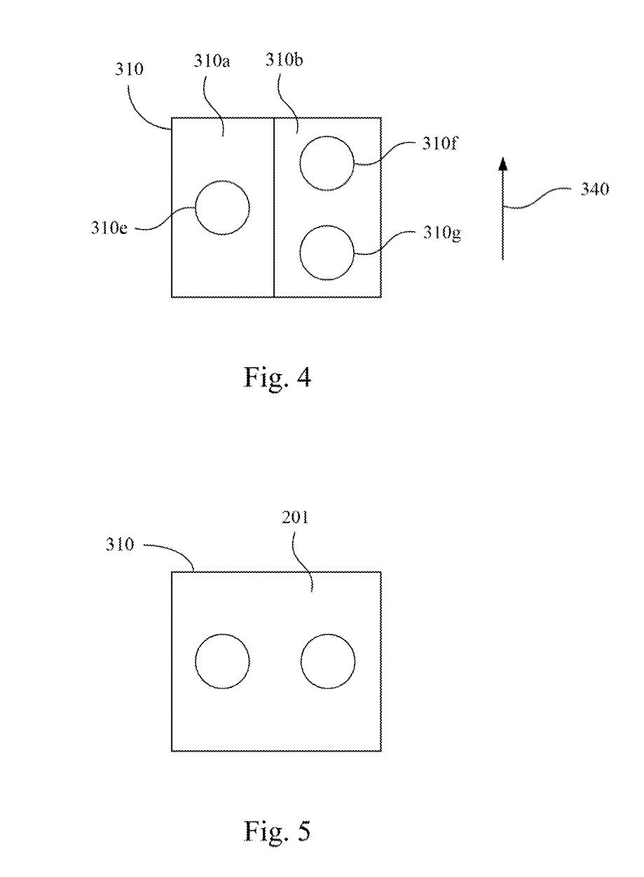

FIG. 4 illustrates an embodiment of the manner in which several menu pages are respectively displayed in the window of the multi-touch-sensitive display unit. In this embodiment, a menu page S1, which includes an object 310e, is displayed in the region 310a of the window of the multi-touch-sensitive display unit 310, and a menu page S2, which includes several objects 310f, 310g, is displayed in the region 310b of the window of the multi-touch-sensitive display unit 310. The menu page S1 corresponds to the menu page 201 of the multi menu pages in FIG. 2, and the object 310e of the menu page S1 is selected from the objects 201a, 201b of the corresponding menu page 201. The menu page S2 corresponds to the menu page 202 of the multi menu pages in FIG. 2, and the objects 310f, 310g of the menu page S2 are selected from the objects 202a, 202b, 202c, 202d of the corresponding menu page 202 of the multi menu pages.

In some embodiments, the method may further include an operation to record use information of each of the objects and to list the objects of each displayed menu page in order according to the use information. The use information of each of the objects may include the record with respect to the frequency of use, recent use or any other information related to the use of the objects. Hence, in some embodiments, at least one of the objects with highest frequency of use is selected to be displayed. In some other embodiments, at least one of the objects which is used recently is selected to be displayed. Furthermore, in one embodiment, to execute selection, the at least one object of each page is selected according to their use information. For example, the object 310e of the menu page S1 is selected according to the use information of the objects 201a, 201b of the corresponding menu page 201. As an example, the preset object 201a or 201b with the highest frequency or recently used may be selected as the object displayed 310e.

In addition, if the number of the at least one object of one of the menu pages is more than one, the objects of this page are sorted in a sequence, which is generated according to the use information of the objects of the corresponding menu page of the multi menu pages. For example, the objects displayed can be sorted in a sequence from the most utilized to the least utilized, which provides convenience to users in finding their favorite objects.

In addition, when a scrolling instruction (signal) with respect to one of the pages which includes several objects is received from the input unit (such as that generated when making a sliding gesture in a slide direction 340 as shown in FIG. 4), the pages displayed in the plurality of regions of the window may be scrolled independently according to another signal received. Therefore, users can find the object they want by making a sliding gesture with respect to the one of the pages.

Furthermore, in some embodiments, when a scrolling instruction (such as that generated when making a sliding gesture in a slide direction 340 as shown in FIG. 4) is received, the pages displayed in the plurality of regions of the window may be scrolled as a whole. Therefore, users can find the object they want by scrolling the objects of all pages.

In some embodiments, the computing device may provide two modes for displaying the pages. When the computing device is in a first mode, all of the menu pages are respectively displayed in the regions as shown in FIG. 4. When the computing device is in a second mode, only one of the menu pages, such as the page 201, is displayed on the whole window 310 of the multi-touch-sensitive display unit as shown in FIG. 5.

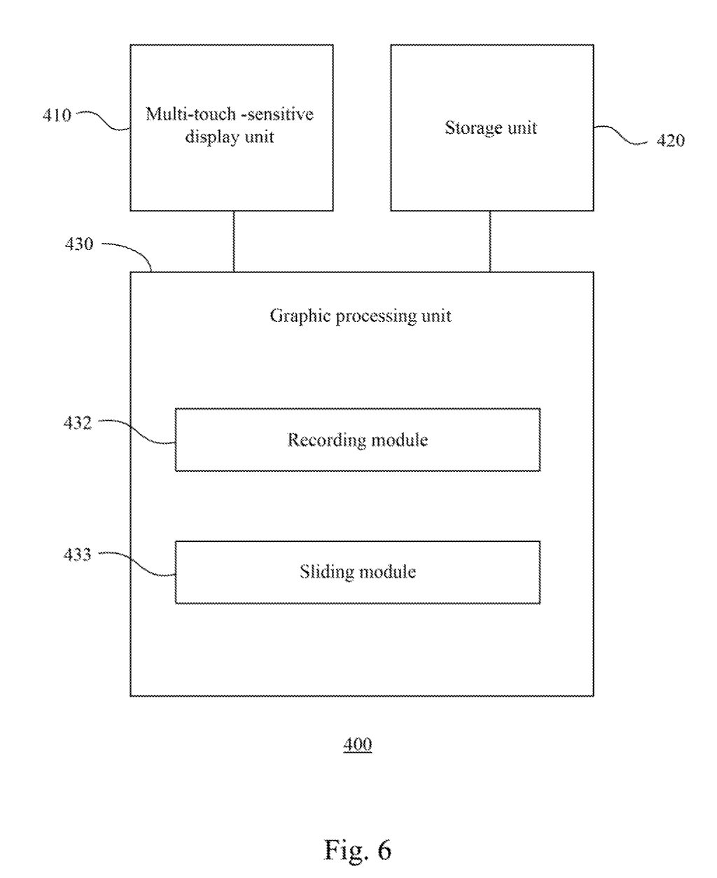

FIG. 6 illustrates a block diagram of a computing device according to one embodiment of this invention.

The computing device 400 includes a multi-touch-sensitive display unit 410, a storage unit 420, a processing unit 430 and an input unit 440. The processing unit 430 is electrically connected to the multi-touch-sensitive display unit 410, the storage unit 420 and the input unit 440.

The storage unit 420 stores multi menu pages . A menu is constituted by multi menu pages and each of the menu pages includes at least one object. Each object may be an icon, a widget, a program or any other object to be displayed on the multi-touch-sensitive display unit 410 of the computing device 400.

The graphic processing unit 430 outputs an image of a menu page to the multi-touch-sensitive display unit 410 and squeezes the current displayed menu page based on a continuous squeezing signal detected by a touch sensor 411 of the multi-touch-sensitive display unit 410 or the input unit 440 until each of the displayed menu pages in the window includes only a portion of the original content thereof. At least one object of each menu page is displayed in each corresponding squeezed menu page of the window of the multi-touch-sensitive to display unit 410. The object displayed in each corresponding squeezed menu page is selected from the corresponding menu page. In one embodiment, the at least one displayed object of each of the menu pages is part of the objects (or only a portion of the original content in each corresponding squeezed menu page) of the corresponding menu page. In another embodiment, the at least one displayed objects of each of the menu pages is all of the objects of the corresponding menu pages.

Subsequently, objects in different menu pages can be provided on the window of the multi-touch-sensitive display unit 410 of the computing device 400 for selection at the same time. Therefore, a user can select objects in different menu pages without switching among the pages to search for a particular object. Hence, convenience is provided to users. In some embodiments, when the multi-touch-sensitive display unit 410 of the computing device 400 is a touch screen, a user does not have to make sliding gestures on the touch screen for objects in different pages utilizing the present application. This provides for particular convenience when the number of the pages is large.

The graphic processing unit 430 may include a recording module 432. The recording module 432 records use information of each of the objects. The use information of each of the objects may include the record with respect to the frequency of use or recent use or any other information related to the use of the objects when users utilize the computing device 400.

Subsequently, in one embodiment, the graphic processing unit 430 may select the at least one of the objects to be displayed in the menu pages according to the use information of the objects. For example, the graphic processing unit 430 may select at least one of the objects with highest o frequency to be displayed. In another embodiment, the region display module 431 may select at least one of the objects which is used recently to be displayed.

In addition, if the number of the at least one display object of one of the menu pages is more than one, the graphic processing unit 430 may further lists the objects of each displayed menu page in order and outputs the image of the objects in the window of the multi-touch-sensitive display unit 410 according to the use information recorded by the recording module. For example, the graphic processing unit 430 may list the displayed objects in an order from the most utilized to the least utilized, which provides convenience to users in finding their favorite objects.

The processing unit 430 may further include a scrolling module 433. When a scrolling instruction with respect to one of the pages which includes several displayed objects is received from the input unit 440, the scrolling module 433 may scroll the at least two squeezed menu pages of the window independently or as a whole. Therefore, users can find the object they want by making a sliding gesture to generate the scrolling instruction with respect to the one of the display object sets.

In some embodiments, when a scrolling instruction is received, the scrolling module 433 may scroll the displayed objects of all pages as a whole according to the scrolling instruction. Therefore, users can find the object they want by scrolling the displayed objects of all pages.

Furthermore, the computing device 400 may provide two modes for displaying the objects. When the computing device 400 is in a first mode, the graphic processing unit 430 outputs all of the menu pages to the window of the multi-touch-sensitive display unit 410. When the computing device 400 is in a second mode, the graphic processing unit 430 outputs only one of the menu pages in the whole window of the multi-touch-sensitive display unit 410.

The present invention can achieve many advantages. A user can select objects in different pages without switching among the pages to search for a is particular object. Hence, convenience is provided to users. In some embodiments, when the multi-touch-sensitive display unit of the computing device is a touch screen, a user does not have to make sliding gestures on the touch screen for objects in different pages utilizing the present application. This provides for particular convenience when the number of the preset menu pages is large.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for displaying multi menu pages in one window of a multi-touch-sensitive display unit of a computing device, wherein a menu is constituted by a plurality of menu pages and each of the menu pages comprises at least one object, the method comprises:
displaying an image of one of the plurality of menu pages in the window of the multi-touch-sensitive display unit;
detecting a continuous squeezing signal by a touch sensor of the multi-touch-sensitive display unit or an input unit of the computing device; and
a graphic module processing the continuous squeezing signal and displaying the current squeezed menu page until at least two menu pages being displayed in the window of the multi-touch-sensitive display unit, wherein each of the displayed menu pages in the window comprises only a portion of the original content thereof.

2. The method of claim 1 further comprising:
recording use information of each of the objects and listing the objects of each displayed menu page in order according to the use information.

3. The method of claim 2, wherein the use information comprises the record with respect to the frequency of use or recent use of each object.

4. The method of claim 1 further comprising:
scrolling the at least two squeezed menu pages in the window of the multi-touch-sensitive display unit independently or as a whole according to another signal received by the touch sensor of the multi-touch-sensitive display unit or the input unit.

5. The method of claim 1, wherein the at least two squeezed menu pages in the window of the multi-touch-sensitive display unit is in a vertical arrangement or in a horizontal arrangement.

6. The method of claim 1, wherein each of the objects may be an icon, a widget, or a program.

7. The method of claim 1, wherein:
all of the plurality of menu pages are displayed in the window of the multi-touch-sensitive display unit when the computing device is in a first mode; and
only one of the plurality of menu pages is displayed in the window of the multi-touch-sensitive display unit when the computing device is in a second mode.

8. A computing device comprising:
a multi-touch-sensitive display unit;
an input unit;
a storage unit for storing a menu constituted by a plurality of menu pages and each of the menu pages comprises at least one object; and
a graphic processing unit electrically connected to the multi-touch-sensitive display unit, the input unit and the storage unit, wherein the graphic processing unit outputs an image of a menu page to the multi-touch-sensitive display unit and squeezes the current displayed menu page based on a continuous squeezing signal detected by a touch sensor of the multi-touch-sensitive display unit or the input unit until each of the displayed s menu pages in the window comprises only a portion of the original content thereof.

9. The computing device of claim 8, wherein the graphic processing unit comprises:
a recording module for recording use information of each of the objects, wherein the graphic processing unit lists the objects of each displayed menu page in order and outputs the image of the objects in the window of the multi-touch-sensitive display unit according to the use information recorded by the recording module.

10. The computing device of claim 9, wherein the use information comprises the record with respect to the frequency of use or recent use of each of the objects.

11. The computing device of claim 8, wherein the graphic processing unit comprises:
a scrolling module for scrolling the at least two squeezed menu pages in the window of the multi-touch-sensitive display unit independently or as a whole according to another signal received by the touch sensor of the multi-touch-sensitive display unit or the input unit.

12. The computing device of claim 8, wherein the graphic processing unit outputs all of the plurality of menu pages to the window of the multi-touch-sensitive display unit when the computing device is in a first mode, and outputs only one of the menu pages in the whole window of the multi-touch-sensitive display unit when the computing device is in a second mode.
